(19) United States
(12) Patent Application Publication
(10) Pub. No.: US 2016/0226304 A1
(43) Pub. Date: Aug. 4, 2016

(54) Electrical power generation system

(71) Applicant: Francisco L. Castro, Houston, TX (US)

(72) Inventor: Francisco L. Castro, Houston, TX (US)

(21) Appl. No.: 14/610,592

(22) Filed: Jan. 30, 2015

(51) Int. Cl. H02J 9/06; H02J 7/00

(52) U.S. Cl. CPC H02J 9/062; H02J 7/0068

(57) ABSTRACT

A power supply generator which uses a battery, charger and inverter to supply AC power directly into electrical lines. The charger allows for the power supply to be used as a main source of power and not just as a backup. The charger supplies a constant DC power source to the battery. The battery is capable of supplying a stable DC power source. The inverter changes the DC power to AC power, and the transformer transfers the energy directly to the electrical lines.

### NONPROVISIONAL PATENT

This patent claims the benefit of 61933056

### BACKGROUND

The present invention relates to systems for generating electricity. Electricity generation is the process of generating electrical power from other sources of primary energy. The basic method of generating electricity still in use t day is the movement of a loop of wire, or disc of copper between the poles of a magnet. Electricity is normally generated at central stations and then distributed through power lines to customers. Today the central stations mainly rely on coal, nuclear, natural gas, hydroelectric, wind generators, and petroleum, with a small amount from solar energy, tidal power, and geothermal sources. The present system provides a simple and efficient means of generating electricity without primary resources.

### SUMMARY

One of the objectives of the present invention is to provide a continuous supply of electricity for consumer homes without the use of primary resources. The system uses a battery, charger and inverter to supply AC power which is distributed upon electrical power lines. The charger provides a continuous un-interruptible power supply to be used as a main source of power and not just as a backup. The charger supplies a constant DC power source to the battery. The battery is capable of supplying a stable DC power source. The inverter changes the DC power to AC power, and the transformer enhances the voltage to allow the transfer and distribution of the energy directly to the electrical power lines and then into the consumer homes.

### BRIEF DESCRIPTION OF DRAWINGS

FIG. 1 is a block diagram of the system.

### SPECIFICATIONS

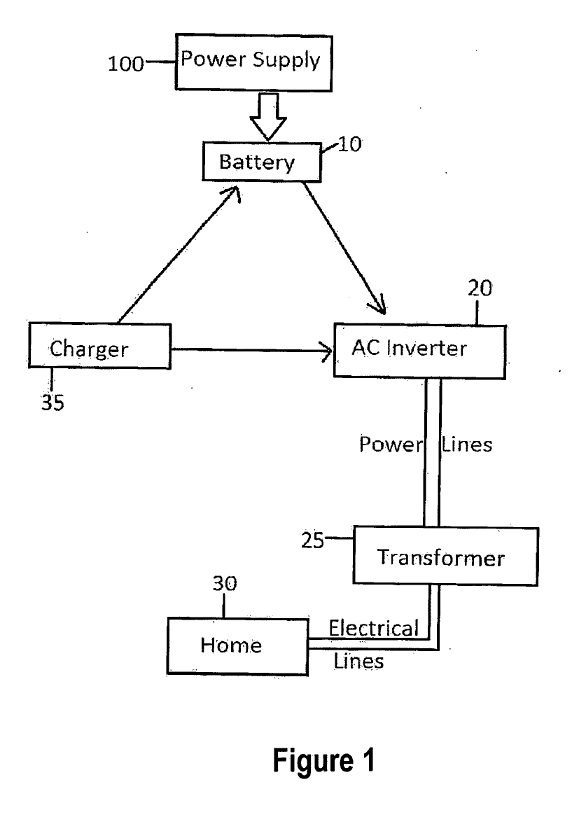

FIG. 1 illustrates the components of the present invention, power supply generator (100). Power supply generator (100) of the present invention comprises an electric battery (10) connected to a charger (35).

An electric battery is a device that convert stored chemical energy into electrical energy. Each battery consists of a negative electrode material, a positive electrode material, an electrolyte that allows ions to move between the electrodes, and terminals that allow current to flowout of the battery to perform work.

Secondary batteries, also known as secondary cells, or rechargeable batteries, can be used in the present invention. Rechargeable batteries are (re)charged by applying electric current, which reverses the chemical reactions that occur during discharge/use. Charger (35) supplies the appropriate current are called chargers.

Battery (10) comprises one or more electrochemical cells that convert stored chemical energy into electrical energy. A wet cell battery has a liquid electrolyte. Other names are flooded cell, since the liquid covers all internal parts, or vented cell, since gases produced during operation can escape to the air. A dry cell uses a paste electrolyte, with only enough moisture to allow current to flow. A common dry cell is the zinc-carbon battery, sometimes called the dry Leclanche cell, with a nominal voltage of 1.5 volts.

Battery (10) capacity is the amount of electric charge it can deliver at the rated voltage. The more electrode material contained in the cell the greater its capacity. A small cell has less capacity than a larger cell with the same chemistry. Capacity is measured in units such as amp-hour (A·h).

The rated capacity of a battery is usually expressed as the product o f 20 hours multiplied by the current that a new battery can consistently supply for 20 hours at 68° F. (20° C.), while remaining above a specified terminal voltage per cell. For example, a battery rated at 100 A·h can deliver 5 A over a 20-hour period at room temperature.

Battery charger (35) is used to put energy into a secondary cell or rechargeable battery. There are several types of battery chargers. For example, simple battery chargers supply a constant DC power source to the battery; a trickle charger is a low-current charger that are used for smaller batteries; time based chargers stop charging after a predetermined time; and a smart charger can respond to the condition of a battery and modify its charging actions accordingly. A battery charger is denoted it terms of charge rate which is a charge or discharge rate equal to the capacity of a battery in an hour.

A power inverter, (20) or inverter, which is also connected to battery (10) is an electronic device or circuitry that changes direct current (DC) to alternating current (AC) and requires a relatively stable DC power source capable of supplying enough current for the intended overall power handling of the inverter. Charger (35) is the device in this configuration that supplies the DC power. Other possible DC power supplies operating off of the power company line, and solar cells. The inverter does not produce any power, the power is provided by the DC source. The inverter translates the form of the power from direct current to an alternating current waveform. The level of the needed input voltage depends entirely on An inverter can produce square wave, modified sine wave, pulsed sine wave, or sine wave depending on circuit design. The two dominant commercialized waveform types of inverters as of 2007 are modified sine wave and sine wave. There are two basic designs for producing household plug-in voltage from a lower-voltage DC source, the first of which uses a switching boost converter to produce a higher-voltage DC and then converts to AC. The second method converts DC to AC at battery level and uses a line-frequency transformer to create the output voltage. A power inverter device which produces a smooth sinusoidal AC waveform is referred to as a sine wave inverter. To more clearly distinguish from “modified sine wave” or other creative terminology, the phrase pure sine wave inverter is sometimes used. In situations involving power inverter devices which substitute for standard line power, a sine wave output is extremely desirable because the vast majority of electric plug in products and appliances are engineered to work well with the standard electric utility power which is a true sine wave. At present, sine wave inverters The AC output voltage of a power inverter device is often the same as the standard power line voltage, such as household 120 VAC or 240 VAC. This allows the inverter to power numerous types of equipment designed to operate off the standard line power. The designed for output voltage is

Transformers are essential for the transmission, distribution, and utilization of electrical energy. Transformer (25) is a device that transfers energy by inductive coupling between its winding circuits through amplifying the AC current voltage from the inverter and placing the electricity upon the power lines to be distributed to the consumer.

What is claimed is:

1. An un-interruptible power supply comprising:
a battery;
the battery coupled to an AC Inverter;
a charger in electronic communication with battery and the AC Invertor; and
the AC Invertor coupled to a transformer wherein electrical power is supplied to the home.
